(19) United States
(12) Patent Application Publication
(10) Pub. No.: US 2025/0251338 A1
(43) Pub. Date: Aug. 7, 2025

(54) OPTICAL MONITORING DEVICE

(71) Applicant: SAMSUNG ELECTRONICS CO., LTD., Suwon-si (KR)

(72) Inventors: Ohkyu KWON, Suwon-si (KR); Wooram HONG, Suwon-si (KR); Youngchun KWON, Suwon-si (KR); Hyunjeong JEON, Suwon-si (KR); Joonhyuk CHOI, Suwon-si (KR); Hyun Do CHOI, Suwon-si (KR)

(73) Assignee: SAMSUNG ELECTRONICS CO., LTD., Suwon-si (KR)

(21) Appl. No.: 19/008,333

(22) Filed: Jan. 2, 2025

(30) Foreign Application Priority Data
Feb. 2, 2024 (KR) 10-2024-0016461

(51) Int. Cl. G01N 21/03; G01N 21/01; G01N 21/17; G01N 21/84

(52) U.S. Cl. CPC G01N 21/0332; G01N 21/17; G01N 2021/0106; G01N 2021/0367; G01N 2021/1765; G01N 2021/8477

(57) ABSTRACT

An optical monitoring device includes: a heating stirrer configured to generate at least one of thermal energy and vibration energy; a jig disposed on the heating stirrer and configured to fix, relative to the optical monitoring device, at least one of a container and a conduit; a light source arranged to emit light toward the at least one of the container and the conduit; a camera arranged and configured to obtain an image of the at least one of the container and the conduit; and an adjuster configured to adjust at least one of a position and an orientation of at least one of the light source and the camera.

### CROSS-REFERENCE TO RELATED APPLICATION

This application claims priority to Korean Patent Application No. 10-2024-0016461, filed on Feb. 2, 2024, in the Korean Intellectual Property Office, the disclosure of which is incorporated by reference herein in its entirety.

### BACKGROUND

### 1. Field

Embodiments of the disclosure relate to an optical monitoring device, and more particularly, to an optical monitoring device for monitoring a recrystallization reaction in real time.

### 2. Description of Related Art

In art related to this disclosure, there were attempts development of a device to analyze patterns of light by transmitting light, of a predetermined wavelength range, through a liquid sample and receiving the unabsorbed light. When the path of light formed between the light source, sample, and detector is precisely configured, repetitive and reproducible measurement results may be obtained. Such device had not been successfully developed.

### SUMMARY

One or more embodiments may address at least the problems and/or disadvantages described above, and other disadvantages not described above. Also, the embodiments are not required to overcome and may not overcome any of the problems and disadvantages described above. According to an aspect of the disclosure, there is an optical monitoring device including: a heating stirrer configured to generate at least one of thermal energy and vibration energy; a jig disposed on the heating stirrer and configured to fix, relative to the optical monitoring device, at least one of a container and a conduit; a light source arranged to emit light toward the at least one of the container and the conduit; a camera arranged and configured to obtain an image of the at least one of the container and the conduit; and an adjuster configured to adjust at least one of a position and an orientation of at least one of the light source and the camera.

The adjuster may also include at least one of: a first guide configured to move the light source along an optical axis between the light source and the camera.

The adjust may also include a second guide configured to move the light source in a direction substantially orthogonal to an optical axis between the light source and the camera.

The adjuster may also include a third guide configured to move the camera along the optical axis.

The adjuster may also include a fourth guide configured to move the camera in the direction substantially orthogonal to the optical axis.

The adjuster may include a light source housing configured to accommodate the light source.

The adjuster may further include a first mount configured to mount the camera on the light source housing.

The adjuster may include a camera housing configured to accommodate the camera

The adjuster may further include a second mount configured to mount the camera on the camera housing

The light source, the jig, and the camera may be arranged in a row.

The camera may be positioned to obtain a surface image of the at least one of the container and the conduit.

The light source and the camera are spaced apart from the heating stirrer by a gap.

The optical monitoring device may further include a thermal insulator configured to insulate the light source and the camera from the heating stirrer.

The optical monitoring device may further include a cooler configured to reduce heat generated from the heating stirrer.

The adjuster may include a hinge configured to tilt at least one of the light source and the camera.

The adjuster may include an actuator configured to tilt at least one the light source and the camera.

According to an aspect of the disclosure, a platform system includes: a plurality of optical monitoring devices, wherein each of the plurality of optical monitoring devices includes: a heating stirrer configured to generate at least one of thermal energy and vibration energy; a jig disposed on the heating stirrer and configured to fix, relative to a respective one of the optical monitoring devices, at least one of a container and a conduit; a light source arranged to emit light toward the at least one of the container and the conduit; a camera arranged and configured to obtain an image of the at least one of the container and the conduit; and an adjuster configured to adjust at least one of a position and an orientation of at least one of the light source and the camera; and a controller configured to control the plurality of optical monitoring devices.

The controller may be further configured to control the adjuster.

The controller may be further configured to control a luminous intensity of the light source.

The platform system may further include a processor configured to analyze an image obtained from a respective camera of each of the plurality of optical monitoring devices.

### BRIEF DESCRIPTION OF THE DRAWINGS

The foregoing and other aspects, features, and advantages of embodiments in the disclosure will become apparent from the following detailed description with reference to the accompanying drawings, in which:

FIG. 1 is a block diagram illustrating a platform system according to one or more embodiments of this disclosure;

FIG. 2 is a perspective view of an optical monitoring device according to one or more embodiments of this disclosure;

FIG. 3 is a plan view of the optical monitoring device according to one or more embodiments of this disclosure;

FIG. 4 is a side view of the optical monitoring device according to one or more embodiments of this disclosure;

FIG. 5 is a perspective view of an adjuster of a light source of the optical monitoring device, according to one or more embodiments of this disclosure;

FIG. 6 is an exploded perspective view of the adjuster of the light source of the optical monitoring device, according to one or more embodiments of this disclosure;

FIG. 7 is a perspective view of an adjuster of a camera of the optical monitoring device, according to one or more embodiments of this disclosure;

FIG. 8 is an exploded perspective view of the adjuster of the camera of the optical monitoring device, according to one or more embodiments of this disclosure;

FIG. 9 is a diagram schematically illustrating an optical monitoring device according to one or more embodiments of this disclosure;

FIG. 10 is a diagram schematically illustrating an optical monitoring device according to one or more embodiments of this disclosure;

FIG. 11 is a diagram schematically illustrating the optical monitoring device according to one or more embodiments of this disclosure;

FIG. 12 is a diagram schematically illustrating an optical monitoring device according to one or more embodiments of this disclosure; and

FIG. 13 is a block diagram of a platform system according to one or more embodiments of this disclosure.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” include the plural forms as well, unless the context clearly indicates otherwise. It will be further understood that any of the terms “comprises”, “comprising”, “includes”, and “including” when used herein, specify the presence of stated features, integers, steps, operations, elements, components, or groups thereof but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The same name may be used to describe an element included in the embodiments described above and an element having a common function. Unless stated otherwise, the description of an embodiment may be applicable to other embodiments, and a repeated description related thereto is omitted.

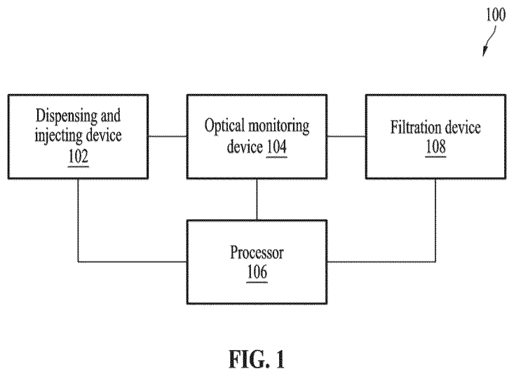

FIG. 1 is a block diagram illustrating a platform system according to one or more embodiments of this disclosure.

Referring to FIG. 1, a platform system 100 may determine, through in-line monitoring, whether recrystallization is performed in a recrystallization process and based on the determination result, may quantitatively produce justification for whether to change a recrystallization condition. The platform system 100 may include a dispensing and injecting device 102, an optical monitoring device 104, a processor 106, and a filtration device 108. The dispensing and injecting device 102 may inject a solvent into a container (e.g., a vial) or a conduit, in which a target compound and a mixture with small amounts of impurities are contained, and may mix and dissolve the compound, the mixture, and the solvent. While the mixed solution produced by the dispensing and injecting device 102 is heated and cooled, the optical monitoring device 104 may optically monitor a process in which the solubility of the solution is reduced and a compound crystal with high purity is produced. While the compound crystal is produced, impurities may remain in a saturated solution surrounding a solid. The filtration device 108 may obtain a high-purity target substance by filtering the compound crystal. The platform system 100 may obtain a greater quantity of high-purity compounds by repeatedly performing the process described above. The processor 106 may determine a different recrystallization condition for each solution while repeatedly performing the process, such as the recrystallization and in-line monitoring described herein. This may increase the purity of a substance and reduce the processing time and costs.

The platform system 100 may be applied to examples other than the example described above. The platform system 100 may be used to enhance the purity of a product at a predetermined reaction stage in a multi-stage reaction for obtaining a high-purity substance and reintroduce the product as a product for the subsequent reaction stage, thereby establishing a favorable condition for subsequent reactions and improving reaction yield. The platform system 100 may be used for a process in which crystallization is crucial, such as any of a safety device for monitoring an abnormal state, a data collection device for analyzing a processing result, and the like. Furthermore, the platform system 100 may be applied to a recrystallization condition search device that performs screening rapidly with small amounts of substances for the purpose of selecting an appropriate solvent, which is crucially considered for a successful recrystallization reaction. The platform system 100 may also be applied to a process monitoring device that extracts a processing condition for large-scale production and determines the presence of abnormalities, in addition to research facilities focused on solvent screening and recrystallization.

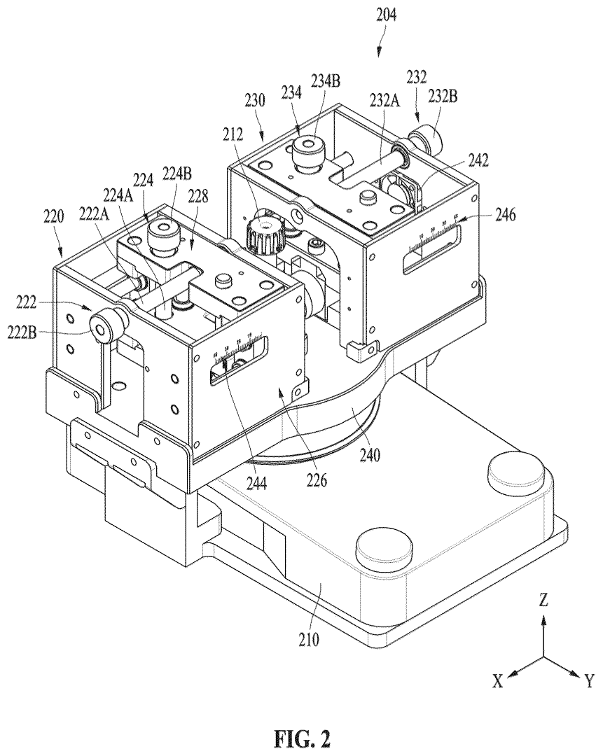

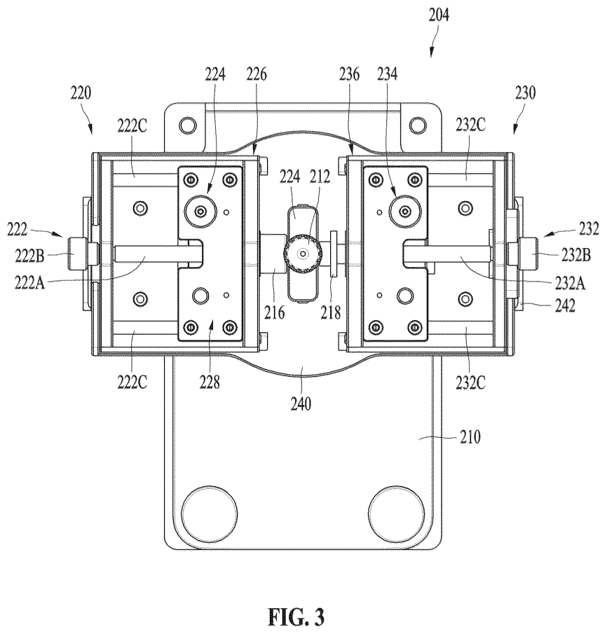

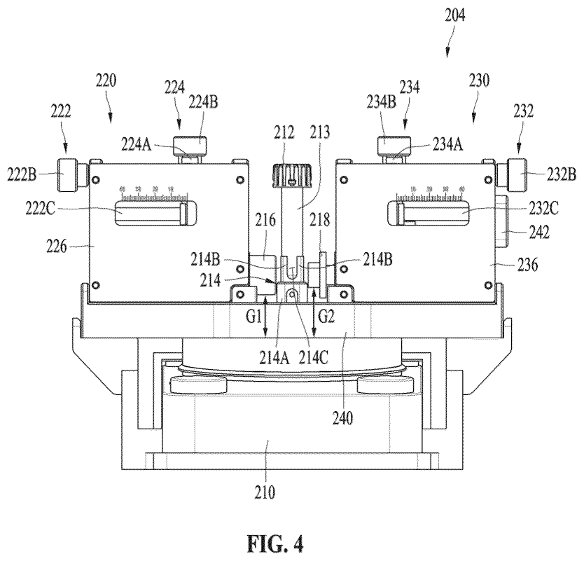

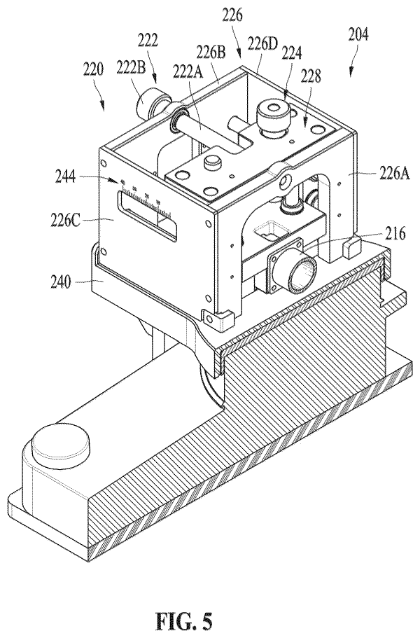

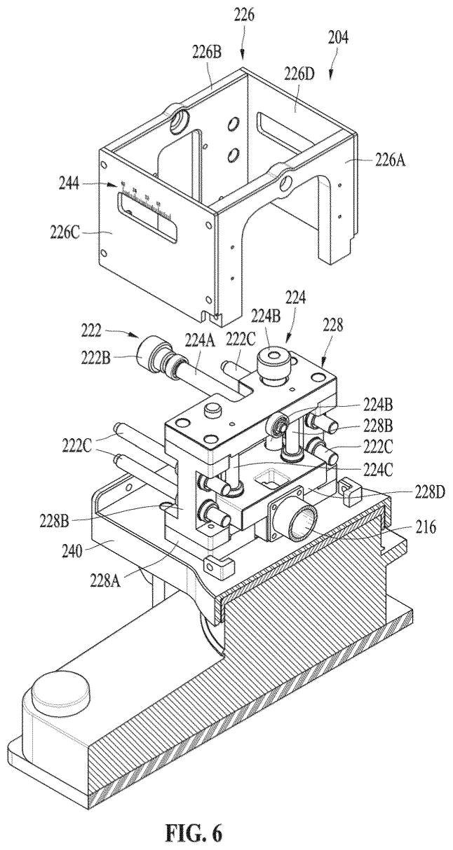

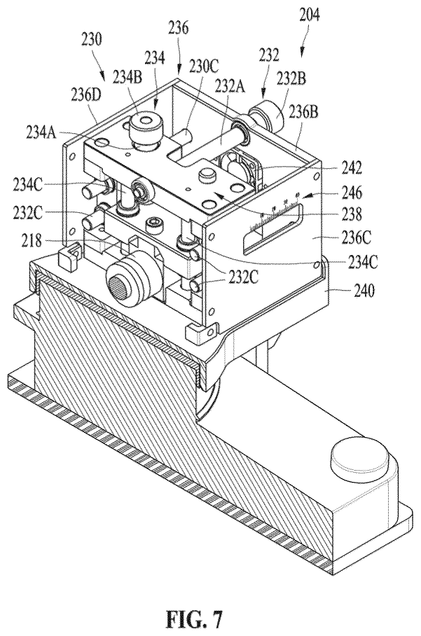

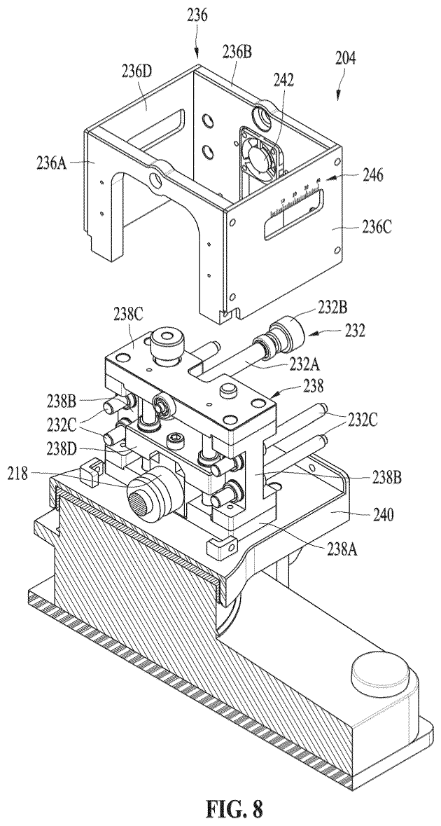

FIG. 2 is a perspective view of an optical monitoring device according to one or more embodiments of this disclosure. FIG. 3 is a plan view of the optical monitoring device according to one or more embodiments of this disclosure. FIG. 4 is a side view of the optical monitoring device according to one or more embodiments of this disclosure. FIG. 5 is a perspective view of an adjuster of a light source of the optical monitoring device according to one or more embodiments of this disclosure. FIG. 6 is an exploded perspective view of the adjuster of the light source of the optical monitoring device according to one or more embodiments of this disclosure. FIG. 7 is a perspective view of an adjuster of a camera of the optical monitoring device according to one or more embodiments of this disclosure. FIG. 8 is an exploded perspective view of the adjuster of the camera of the optical monitoring device according to one or more embodiments of this disclosure.

Referring to FIG. 2, FIG. 3, FIG. 4, FIG. 5, FIG. 6, FIG. 7, and FIG. 8, an optical monitoring device 204, which may also be or may be a version of the optical monitoring device 104 of FIG. 1 according to one or more embodiments of this disclosure, may determine whether to recrystallize a substance through image analysis under the same condition as an actual reaction and a recrystallization condition. The optical monitoring device 204 may include a light source 216 and a camera 218; see FIG. 3, FIG. 4, FIG. 5, FIG. 6, FIG. 7, and FIG. 8 for example. The light source 216 faces a container 212, is spaced apart from the container 212, and is arranged to emit light toward the container 212, wherein the container 212, also illustrated in FIG. 2, is transparent and contains a substance. The camera 218 faces the container 212, is spaced apart from the container 212, and is configured to obtain an image (e.g., a surface image) of the container 212. The light source 216, the container 212, and the camera 218 may be substantially arranged in a row on the same line. A processor (e.g., the processor 106 of FIG. 1) may determine the degree of crystal formation by capturing a crystal shape through interpreting the obtained image and integrating the captured crystal areas.

The optical monitoring device 204 may include a jig 214, including jig base 214A, jig columns 214B, and slots 214C (the jig base 214A, jig columns 214B, and slots 214C being collectively herein referred to as “jig” unless otherwise specified), configured to fix the container 212; see FIG. 4, FIG. 5, FIG. 6, FIG. 7, and FIG. 8 for example. The jig may be thermally coupled to a heating stirrer 210. Thermal energy and/or vibration energy generated from the heating stirrer 210 may be transferred to the container 212 through the jig 214. The jig 214 may include a jig base 214A disposed on the heating stirrer 210, a plurality of jig columns 214B disposed on the jig base 214A, arranged along the perimeter of the jig base 214A, and partially surrounding the container 212, and a plurality of slots 214C defined between a pair of adjacent jig columns 214B and partially exposing the outer surface of the container 212. One of the plurality of slots 214C may be aligned with the light source 216 and another slot may be aligned with the camera 218.

The optical monitoring device 204 may include a first adjuster 220 configured to adjust the position of the light source 216. While an image is obtained and analyzed in real time during a recrystallization reaction, the first adjuster 220 may adjust the position (e.g., a position in the Z-axis direction) of the light source 216 along the length of the container 212 and/or the position (e.g., a position in the X-axis direction) of the light source 216 with respect to the width or diameter of the container 212.

The first adjuster 220 may include a first guide 222 configured to guide the light source 216 along an optical axis (e.g., X-axis) defined between the light source 216 and the camera 218. The first guide 222 may include a first main rail 222A extending in a first direction (e.g., X-axis direction). The first guide 222 may include a first knob 222B configured to adjust the position of the light source 216 along the first main rail 222A and fix the light source 216 to a target position. The first knob 222B may be rotated by an operator. The first guide 222 may include a plurality of first sub-rails 222C extending substantially parallel to the first main rail 222A.

The first adjuster 220 may include a second guide 224 configured to guide the light source 216 in the direction (e.g., Z-axis direction) substantially orthogonal to the optical axis (e.g., X-axis) defined between the light source 216 and the camera 218. The second guide 224 may include a second main rail 224A extending in a second direction (e.g., Z-axis direction). The second guide 224 may include a second knob 224B configured to adjust the position of the light source 216 along the second main rail 224A and fix the light source 216 to the target position. The second knob 224B may be rotated by the operator. The second guide 224 may include a plurality of second sub-rails 224C extending substantially parallel to the second main rail 224A.

The optical monitoring device 204 may include a light source housing 226 configured to accommodate the light source 216. The light source housing 226 may include a first front panel 226A disposed in the direction (e.g., −X direction) facing the container 212. The first front panel 226A may define an opening through which the light source 216 may at least partially pass. The light source housing 226 may include a first rear panel 226B disposed opposite to (e.g., +X direction) the first front panel 226A. The first main rail 222A and the plurality of first sub-rails 222C may be connected to the first front panel 226A and the first rear panel 226B. The light source housing 226 may include a plurality of first side panels 226C and 226D disposed between the first front panel 226A and the first rear panel 226B.

The optical monitoring device 204 may include a first mount 228 configured to mount the light source 216 on the light source housing 226. The first mount 228 may include a first base block 228A disposed on the heating stirrer 210. The first mount 228 may include a plurality of first side blocks 228B coupled to both sides of the first base block 228A. At least one of the plurality of first sub-rails 222C may be connected to one of the first side blocks 228B, while at least one other first sub-rail 222C may be connected to another first side block 228B. The plurality of first side blocks 228B may move in the first direction (e.g., X-axis direction) along the plurality of first sub-rails 222C toward the first rear panel 226B or away from the first rear panel 226B. The first mount 228 may include a second base block 228C coupled to the tops of the first side blocks 228B. The first main rail 222A may be connected to the second base block 228C. The second base block 228C may move in the first direction (e.g., X-axis direction) along the first main rail 222A. The second main rail 224A and the plurality of second sub-rails 224C may be connected to the second base block 228C. The first mount 228 may include a third base block 228D disposed between the plurality of first side blocks 228B. The third base block 228D may be coupled to the light source 216. The third base block 228D may be coupled to the first base block 228A. The second main rail 224A and the plurality of second sub-rails 224C may be connected to the third base block 228D. The third base block 228D may move in the second direction (e.g., Z-axis direction) between the first base block 228A and the second base block 228C along the second main rail 224A and the plurality of second sub-rails 224C.

The optical monitoring device 204 may include a second adjuster 230 configured to adjust the position of the camera 218. While an image is obtained and analyzed in real time during a recrystallization reaction, the second adjuster 230 may adjust the position (e.g., a position in the Z-axis direction) of the camera 218 along the length of the container 212 and/or the position (e.g., a position in the X-axis direction) of the light source 216 with respect to the width or diameter of the container 212.

The second adjuster 230 may include a third guide 232 configured to guide the camera 218 along the optical axis (e.g., X-axis) defined between the light source 216 and the camera 218. The third guide 232 may include a third main rail 232A extending in the first direction (e.g., X-axis direction). The third guide 232 may include a third knob 232B configured to adjust the position of the camera 218 along the third main rail 232A and fix the camera 218 to a target position. The third knob 232B may be rotated by the operator. The third guide 232 may include a plurality of third sub-rails 232C extending substantially parallel to the third main rail 232A.

The second adjuster 230 may include a fourth guide 234 configured to guide the camera 218 in the direction (e.g., Z-axis direction) substantially orthogonal to the optical axis (e.g., X-axis) defined between the light source 216 and the camera 218. The fourth guide 234 may include a fourth main rail 234A extending in the second direction (e.g., Z-axis direction). The fourth guide 234 may include a fourth knob 234B configured to adjust the position of the camera 218 along the fourth main rail 234A and fix the camera 218 to the target position. The fourth knob 234B may be rotated by the operator. The fourth guide 234 may include a plurality of fourth sub-rails 234C extending substantially parallel to the fourth main rail 234A.

The optical monitoring device 204 may include a camera housing 236 configured to accommodate the camera 218. The camera housing 236 may include a second front panel 236A disposed in the direction (e.g., +X direction) facing the container 212. The second front panel 236A may define an opening through which the camera 218 at least partially passes. The camera housing 236 may include a second rear panel 236B disposed opposite to (e.g., in the −X direction) the second front panel 236A. The second main rail 232A and the plurality of second sub-rails 232C may be connected to the second front panel 236A and the second rear panel 236B. The camera housing 236 may include a plurality of second side panels, such as a second side panel 236C and a second side panel 236D, disposed between the second front panel 236A and the second rear panel 236B.

The optical monitoring device 204 may include a second mount 238 configured to mount the camera 218 on the camera housing 236. The second mount 238 may include a fourth base block 238A disposed on the heating stirrer 210. The second mount 238 may include a plurality of second side blocks 238B coupled to both sides of the fourth base block 238A. At least one of the plurality of third sub-rails 232C may be connected to one of the second side blocks 238B, while at least one other third sub-rail 232C may be connected to another second side block 238B. The plurality of second side blocks 238B may move in the first direction (e.g., X-axis direction) along the plurality of third sub-rails 232C toward the second rear panel 236B or away from the second rear panel 236B. The second mount 238 may include a fifth base block 238C coupled to the tops of the plurality of second side blocks 238B. The third main rail 232A may be connected to the fifth base block 238C. The fifth base block 238C may move in the first direction (e.g., X-axis direction) along the third main rail 232A. The fourth main rail 234A and the plurality of fourth sub-rails 234C may be connected to the fifth base block 238C. The second mount 238 may include a sixth base block 238D disposed between the plurality of second side blocks 238B. The sixth base block 238D may be coupled to the camera 218. The sixth base block 238D may be coupled to the fourth base block 238A. The fourth main rail 234A and the plurality of fourth sub-rails 234C may be connected to the sixth base block 238D. The sixth base block 238D may move in the second direction (e.g., Z-axis direction) between the fourth base block 238A and the fifth base block 238C along the fourth main rail 234A and the plurality of fourth sub-rails 234C.

The optical monitoring device 204 may include a thermal insulator 240 configured to reduce or block thermal exchange between the light source 216 and the heating stirrer 210 and between the camera 218 and the heating stirrer 210. The thermal insulator 240 may be disposed between the light source 216 and the camera 218, and the heating stirrer 210. For example, the thermal insulator 240 may include Teflon. The thermal insulator 240 may have a thickness of at least about 3 millimeters (mm), or at least 3 mm according to one or more embodiments. The thermal insulator 240 may reduce the transfer of heat generated from the heating stirrer 210 to the light source 216 and/or the camera 218, thereby reducing thermal damage to the light source 216 and/or the camera 218. Additionally or alternatively depending on one or more embodiments herein, the optical monitoring device 204 may have a first gap G1, between the light source 216 and the heating stirrer 210, and a second gap G2 between the camera 218 and the heating stirrer 210 without the thermal insulator 240; see FIG. 2 for example. The first gap G1 and the second gap G2 may include an air medium. The first gap G1 and the second gap G2 may have a thickness of at least about 3 mm, or at least 3 mm according to one or more embodiments.

The optical monitoring device 204 may include a cooler 242 configured to reduce the heat generated from the heating stirrer 210. The cooler 242 may include a fan. The cooler 242 may be disposed on the second rear panel 236D. Cooling by the cooler 242 may reduce thermal damage to the components of the optical monitoring device 204.

The optical monitoring device 204 may include a first indicator 244 configured to indicate the position, in the first direction (e.g., X-axis direction), of the light source 216. The first indicator 244 may include a slot with a graduated ruler, the slot at least partially showing a first sub-rail 222C. The first indicator 244 may be disposed on at least one of the plurality of first side panels, such as first side panel 226C and first side panel 226D.

The optical monitoring device 204 may include a second indicator 246 configured to indicate the position, in the first direction (e.g., X-axis direction), of the camera 218. The second indicator 246 may include a slot with a graduated ruler, the slot at least partially showing a third sub-rail 232C. The second indicator 246 may be disposed on at least one of the plurality of second side panels, such as the second side panel 236C and other second side panel 236D.

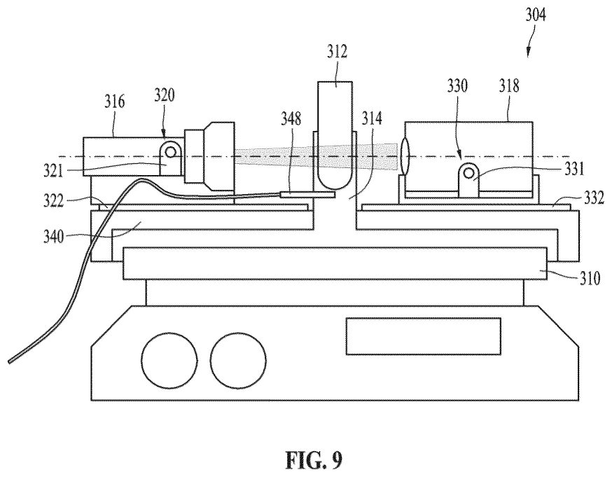

FIG. 9 is a diagram schematically illustrating an optical monitoring device according to one or more embodiments.

Referring to FIG. 9, an optical monitoring device 304 may include a heating stirrer 310, a container 312, a jig 314, a light source 316, a camera 318, a first adjuster 320, a second adjuster 330, and a thermal insulator 340. The first adjuster 320 may include a first guide 322. The second adjuster 330 may include a third guide 332.

The first adjuster 320 may include a first hinge 321. The first hinge 321 may be configured to tilt the light source 316 with respect to a fixing body (e.g., the light source housing 226 of as in at least any of FIG. 2, FIG. 3, FIG. 4, FIG. 5, and FIG. 6). Adjusting the tilt angle of the light source 316 using the first hinge 321 may determine the orientation of the light source 316 to reduce light scattering and/or reflection from a container surface, thereby ensuring that an image of a crystal formed on the container surface may be obtained without optical distortion.

The second adjuster 330 may include a second hinge 331. The second hinge 331 may be configured to tilt the camera 318 with respect to a fixing body (e.g., the camera housing 236 of as in at least any of FIG. 3, FIG. 4, and FIG. 7). Adjusting the tilt angle of the camera 318 using the second hinge 331 may determine the orientation of the camera 318 to reduce light scattering and/or reflection from the container surface, thereby ensuring that an image of a crystal formed on the container surface may be obtained without optical distortion.

The optical monitoring device 304 may include a temperature sensor 348. The temperature sensor 348 may be configured to detect the temperature of the jig 314. The temperature sensor 348 may be physically and thermally coupled to the jig 314. The temperature sensor 348 may include a thermocouple.

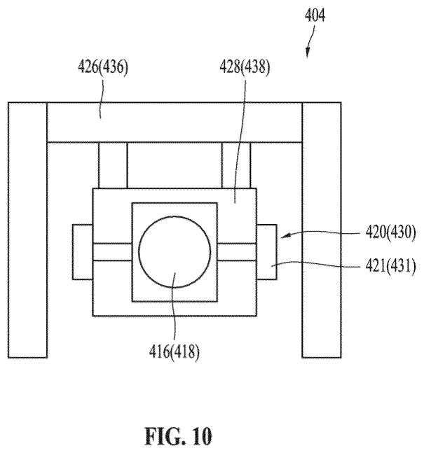

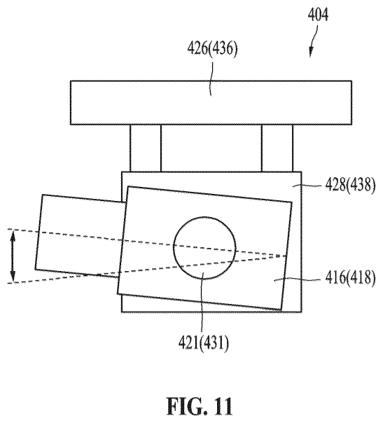

FIG. 10 is a diagram schematically illustrating an optical monitoring device according to one or more embodiments herein. FIG. 11 is a diagram schematically illustrating the optical monitoring device according to one or more embodiments herein.

Referring to FIG. 10 and FIG. 11, an optical monitoring device 404 may include a light source 416, a camera 418, a first adjuster 420, a light source housing 426, a first mount 428, a second adjuster 430, a camera housing 436, and a second mount 438.

The first adjuster 420 may include a first actuator 421. The first actuator 421 may be configured to adjust the tilt angle of the light source 416 with respect to the light source housing 426 and/or the first mount 428. Adjusting the tilt angle of the light source 416 using the first actuator 421 may reduce light scattering and/or reflection from a container surface, thereby ensuring that an image of a crystal formed on the container surface may be obtained without optical distortion.

The second adjuster 430 may include a second actuator 431. The second actuator 431 may be configured to adjust the tilt angle of the camera 418 with respect to the camera housing 436 and/or the second mount 438. Adjusting the tilt angle of the camera 418 using the second actuator 431 may reduce light scattering and/or reflection from the container surface, thereby ensuring that an image of a crystal formed on the container surface may be obtained without optical distortion.

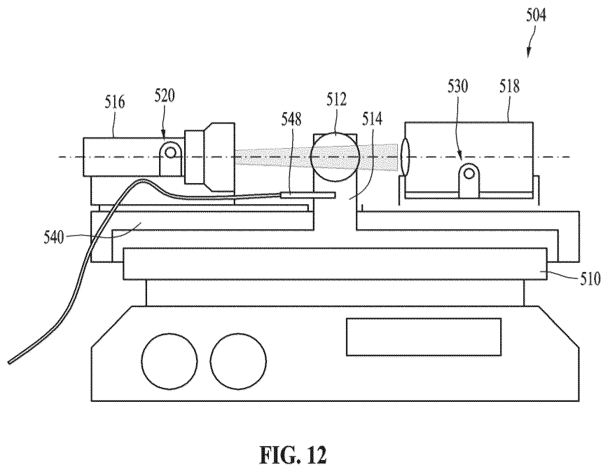

FIG. 12 is a diagram schematically illustrating an optical monitoring device according to one or more embodiments herein.

Referring to FIG. 12, an optical monitoring device 504 may include a heating stirrer 510, a conduit 512, a jig 514, a light source 516, a camera 518, a first adjuster 520, a second adjuster 530, a thermal insulator 540, and a temperature sensor 548. The optical monitoring device 504 may monitor a crystallization condition for a substance flowing through the conduit 512 in real time by disposing, between the light source 516 and the camera 518, the conduit 512 instead of a container. The jig 514, like the jig 314, may include the jig base 214A, jig columns 214B, and slots 214C as described above and illustrated with FIG. 4 according to one or more embodiments herein.

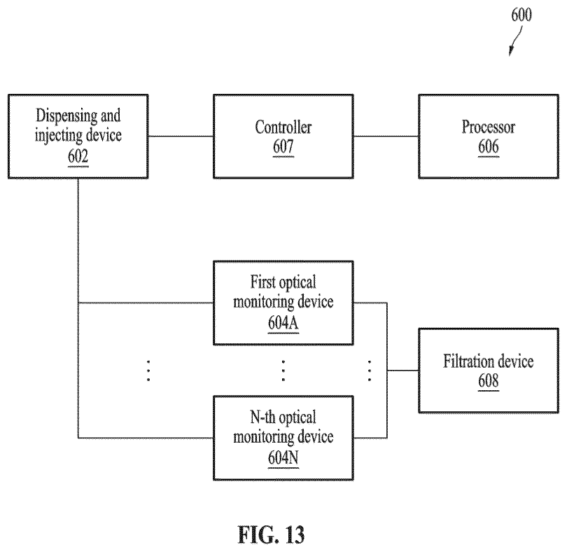

FIG. 13 is a block diagram of a platform system according to one or more embodiments herein.

Referring to FIG. 13, a platform system 600 may include a dispensing and injecting device 602, a plurality of optical monitoring devices, such as optical monitoring device 604A to optical monitoring device 604N, a processor 606, a controller 607, and a filtration device 608. The platform system 600 may accelerate recrystallization condition screening by dispensing different types of substances or the same type of substances to the plurality of monitoring devices, such as optical monitoring device 604A to optical monitoring device 604N, in parallel.

The processor 606 may have an interface that interprets images obtained from each of the plurality of optical monitoring devices, such as optical monitoring device 604A to optical monitoring device 604N, determines whether a crystal is formed, and stores and analyzes the interpretation results.

The controller 607 may be configured to control the components of the plurality of optical monitoring devices, such as optical monitoring device 604A to optical monitoring device 604N. For example, the controller 607 may be configured to control the position and/or orientation conditions of the light source and/or camera of each of the optical monitoring devices, such as optical monitoring device 604A to optical monitoring device 604N. In another example, the controller 607 may be configured to control the luminous intensity of the light source.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as floptical disks; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter. The above-described hardware devices may be configured to act as one or more software modules in order to perform the operations of the embodiments, or vice versa.

The software may include a computer program, a piece of code, an instruction, or one or more combinations thereof, to configure a processing device to operate as desired or independently or collectively instruct the processing device. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

What is claimed is:

1. An optical monitoring device comprising:
a heating stirrer configured to generate at least one of thermal energy and vibration energy;
a jig disposed on the heating stirrer and configured to fix, relative to the optical monitoring device, at least one of a container and a conduit;
a light source configured to emit light toward the at least one of the container and the conduit;
a camera arranged and configured to obtain an image of the at least one of the container and the conduit; and
an adjuster configured to adjust at least one of a position and an orientation of at least one of the light source and the camera.

2. The optical monitoring device of claim 1, wherein the adjuster comprises a first guide configured to move the light source along an optical axis between the light source and the camera.

3. The optical monitoring device of claim 2, wherein the adjuster further comprises a second guide configured to move the light source in a direction substantially orthogonal to an optical axis between the light source and the camera.

4. The optical monitoring device of claim 3, wherein the adjuster further comprises a third guide configured to move the camera along the optical axis, and
a fourth guide configured to move the camera in the direction substantially orthogonal to the optical axis.

5. The optical monitoring device of claim 4, wherein the adjuster further comprises a fourth guide configured to move the camera in the direction substantially orthogonal to the optical axis.

6. The optical monitoring device of claim 1, wherein the adjuster comprises a light source housing configured to accommodate the light source.

7. The optical monitoring device of claim 6, wherein the adjuster further comprises a first mount configured to mount the camera on the light source housing.

8. The optical monitoring device of claim 1, wherein the adjuster comprises a camera housing configured to accommodate the camera.

9. The optical monitoring device of claim 8, wherein the adjuster further comprises a second mount configured to mount the camera on the camera housing.

10. The optical monitoring device of claim 1, wherein the light source, the jig, and the camera are arranged in a row.

11. The optical monitoring device of claim 1, wherein the camera is positioned to obtain a surface image of the at least one of the container and the conduit.

12. The optical monitoring device of claim 1, wherein the light source and the camera are spaced apart from the heating stirrer by a gap.

13. The optical monitoring device of claim 1, further comprising:
a thermal insulator configured to insulate the light source and the camera from the heating stirrer.

14. The optical monitoring device of claim 1, further comprising:
a cooler configured to reduce heat generated from the heating stirrer.

15. The optical monitoring device of claim 1, wherein the adjuster comprises a hinge configured to tilt at least one of the light source and the camera.

16. The optical monitoring device of claim 1, wherein the adjuster comprises an actuator configured to tilt at least one of the light source and the camera.

17. A platform system comprising:
a plurality of optical monitoring devices, wherein each of the plurality of optical monitoring devices comprises:
a heating stirrer configured to generate at least one of thermal energy and vibration energy;
a jig disposed on the heating stirrer and configured to fix, relative to a respective one of the optical monitoring devices, at least one of a container and a conduit;
a light source arranged to emit light toward the at least one of the container and the conduit;
a camera arranged and configured to obtain an image of the at least one of the container and the conduit; and
an adjuster configured to adjust at least one of a position and an orientation of at least one of the light source and the camera; and
a controller configured to control the plurality of optical monitoring devices.

18. The platform system of claim 17, wherein the controller is further configured to control the adjuster.

19. The platform system of claim 17, wherein the controller is further configured to control a luminous intensity of the light source.

20. The platform system of claim 17, further comprising:
a processor configured to analyze an image obtained from a respective camera of each of the plurality of optical monitoring devices.
